(19) United States
(12) Patent Application Publication
(10) Pub. No.: US 2011/0079979 A1
(43) Pub. Date: Apr. 7, 2011

(54) VEHICLE SUSPENSION ARM

(75) Inventor: Shingo Koumura, Shizuoka-ken (JP)

(73) Assignee: TOYOTA JIDOSHA KABUSHIKI KAISHA, TOYOTA-SHI (JP)

(21) Appl. No.: 12/994,305

(22) PCT Filed: May 29, 2009
(86) PCT No.: PCT/IB09/05770

§ 371 Date: Nov. 23, 2010

(30) Foreign Application Priority Data
May 30, 2008 (JP) 2008-142804

(51) Int. Cl. B60G 7/00

(52) U.S. Cl. 280/124.1

(57) ABSTRACT

A vehicle suspension arm (10) coupled at one end thereof to a vehicle body (14) and at the other end thereof to a wheel support member (18) has a pair of arm members (20, 22) that are spaced apart from each other. The pair of the arm members (20, 22) define a centerline (24) of the suspension arm (10) therebetween with the cooperation with each other. The respective arm members (20, 22) have cross-sectional shapes opening to the other side of the centerline (24) side. Thus, shear centers of the respective arm members (20, 22) are located on the centerline (24) side with respect to the arm members (20, 22) respectively.

### BACKGROUND OF THE INVENTION

1. Field of the Invention

The invention relates to a suspension for a vehicle such as an automobile or the like, and more particularly, to a vehicle suspension arm.

2. Description of the Related Art

A suspension arm for a vehicle such as an automobile or the like needs to exhibit lightness in weight and high strength, and therefore, is generally formed of a press-molded steel plate or the like having a cross-sectional shape in which both ends thereof protrude in the same direction. Further, in Published Japanese Translation of PCT application No. 2004-533355 (JP-A-2004-533355), there is described a suspension arm having a pair of arm members molded with a W-shaped cross-section and structured such that the pair of the arm members are coupled at both ends to each other while being spaced apart from each other.

According to the suspension arm press-molded in a cross-sectional shape in which both the ends thereof protrude in the same direction or the suspension arm described in JP-A-2004-533355, there is no need to integrally join outer peripheral portions of the pair of the arm members to each other through welding or the like. Therefore, the suspension arm can be manufactured more efficiently and at lower cost than a hollow tube type suspension arm having a closed cross-sectional shape.

However, by press-molding the suspension arm in a cross-sectional shape in which both the ends thereof protrude in the same direction, a centerline of the suspension arm is located inside the cross-sectional shape in which both the ends protrude in the same direction, but the shear centers of the suspension arm are located outside the cross-sectional shape in which both the ends protrude in the same direction. Thus, when subjected to a torsional stress, the suspension arm is elastically deformed so that the centerline thereof is twisted around a line connecting the shear centers. As a result, the suspension arm inevitably undergoes bending deformation as well as torsional deformation.

Further, in the suspension arm as described in JP-A-2004-533355, the pair of the arm members have a cross-sectional shape in which the pair of the arm members are so open as to face each other. Therefore, a shear center of each of the arm members is located on the other side of a shear center of the other arm member, and there is a large gap between each of the shear centers and the centerline of the suspension arm. Thus, when subjected to a torsional stress, this kind of suspension arm cannot favorably undergo torsional deformation.

### SUMMARY OF THE INVENTION

The invention ensures favorable torsional deformation of a suspension arm when the suspension arm is subjected to torsional stress, and reduces the amount of bending deformation of the suspension arm.

A vehicle suspension arm according to an aspect of the invention is a vehicle suspension arm coupled at one end thereof to a vehicle body and at the other end thereof to a wheel support member. The suspension arm has a pair of arm members spaced apart from each other. The pair of the arm members define a centerline of the suspension arm therebetween with the cooperation with each other. The arm members have shear centers that are located on the centerline side with respect to the arm members respectively.

According to the vehicle suspension arm according to the foregoing aspect of the invention, the pair of the arm members spaced apart from each other define the centerline of the suspension arm therebetween with the cooperation with each other. The shear centers of the arm members are located on the centerline side with respect to the arm members respectively. Accordingly, in comparison with a suspension arm that is formed of a single arm member having a cross-sectional shape in which both ends thereof protrude in the same direction (e.g., a U-shaped cross-section) and has a shear center located on the other side of a centerline with respect to the arm member, or the suspension arm described in JP-A-2004-533355, which has the pair of the arm members whose shear centers are located on the other side of the centerline with respect to the arm members respectively, more favorable torsional deformation of the suspension arm can be ensured without causing excessive bending deformation when the suspension arm is subjected to torsional stress. Thus, the possibility of the suspension arm undergoing excessive bending deformation or being hindered from smoothly operating can be reduced.

Further, in the vehicle suspension arm according to the aspect of the invention, the shear centers of the pair of the arm members may be located on the centerline at least in part of a region between the one end and the other end.

According to the vehicle suspension arm according to the foregoing aspect of the invention, the shear centers of the pair of the arm members are located on the centerline at least in part of the region between one end and the other end. Therefore, more favorable torsional deformation of the suspension arm can be ensured when the suspension arm is subjected to torsional stress, than in a case where the shear centers of the pair of the arm members are spaced apart from the centerline instead of being located on the centerline.

Further, in the vehicle suspension arm according to the aspect of the invention, the shear centers of the pair of the arm members may be equidistantly spaced apart from each other with respect to the centerline at least in part of a region between the one end and the other end.

According to the vehicle suspension arm according to the foregoing aspect of the invention, the shear centers of the pair of the arm members are equidistantly spaced apart from each other with respect to the centerline at least in part of the region between one end and the other end. Therefore, more favorable torsional deformation of the suspension arm can be ensured when the suspension arm is subjected to torsional stress, than in a case where the distance between the shear center of one of the pair of the arm members and the centerline and the distance between the shear center of the other arm member and the centerline are different from each other.

Further, in the vehicle suspension arm according to the aspect of the invention, the pair of the arm members may have cross-sectional shapes that establish a mirror image relationship with each other at least in part of a region between the one end and the other end.

According to the vehicle suspension arm according to the foregoing aspect of the invention, the pair of the arm members have the cross-sectional shapes that establish a mirror image relationship with each other at least in part of the region between one end and the other end. Therefore, the pair of the arm members have cross-sectional shapes that are plane-symmetrical to each other with respect to a virtual plane extending past the centerline. Accordingly, the amount of surplus torsional deformation of the suspension arm can be reduced when the suspension arm is subjected to stress in a direction along the virtual plane or perpendicular thereto, in comparison with a case where the pair of the arm members do not have such cross-sectional shapes.

Further, according to the vehicle suspension arm according to the aspect of the invention, the amount of excess bending deformation of the suspension arm may be reduced when the suspension arm is subjected to compressive stress or tensile stress, along the longitudinal direction thereof, in comparison with to when the pair of the arm members do not have cross-sectional shapes that establish a mirror image relationship with each other.

Further, in the vehicle suspension arm according to the aspect of the invention, the pair of the arm members may be integrally connected to each other by connection means at least one of the one end and the other end.

According to the vehicle suspension arm according to the foregoing aspect of the invention, the pair of the arm members are integrally connected to each other by the connection means at least one of one end and the other end. Therefore, the handling of the suspension arm and the mounting of the suspension arm to the vehicle can be carried out more easily and more efficiently than in a case where the pair of the arm members are not integrally connected to each other by the connection means.

Further, in the vehicle suspension arm according to the aspect of the invention, the connection means may be provided at the one end, and the connection means at the one end may constitute part of vehicle body-side coupling means for pivotably coupling the one end of the suspension arm to the vehicle body.

According to the vehicle suspension arm according to the foregoing aspect of the invention, the connection means at one end constitutes part of the vehicle body-side coupling means for pivotably coupling one end of the suspension arm to the vehicle body. Therefore, the paired arm members may be integrally connected to each other at one end, and the number of components required for the connection means and the vehicle body-side coupling means may be reduced in comparison to when the connection means at one end does not constitute part of the vehicle body-side coupling means.

Further, in the vehicle suspension arm according to the aspect of the invention, the connection means may be provided at the other end, and the connection means at the other end may constitute part of wheel support member-side coupling means for pivotably coupling the other end of the suspension arm to the wheel support member.

According to the vehicle suspension arm according to the foregoing aspect of the invention, the connection means at the other end constitutes part of the wheel support member-side coupling means for pivotably coupling the other end of the suspension arm to the wheel support member. Therefore, the pair of the arm members can be integrally connected at the other end to each other, and the number of components required for the connection means and the wheel support member-side coupling means can be reduced in comparison with a case where the connection means at the other end does not constitute part of the wheel support member-side coupling means.

Further, in the vehicle suspension arm according to the aspect of the invention, the common vehicle body side coupling means may pivotably couple the one ends of the arm members to the vehicle body and connects the one ends of the arm members with each other, and the common wheel support member side coupling means may pivotably couple the other ends of the arm members to the wheel support member and connects the other ends of the arm members with each other.

According to the vehicle suspension arm according to the foregoing aspect of the invention, one end of one of the pair of the arm members and the one end of the other arm member are pivotably coupled to the vehicle body while being integrated with each other by the common vehicle body-side coupling means, and the other end of one of the pair of the arm members and the other end of the other arm member are pivotably coupled to the wheel support member while being integrated with each other by the common wheel support member-side coupling means. Therefore, even when the pair of the arm members are not integrally connected to each other in advance, the suspension arm can be pivotably coupled at one end to the vehicle body, and can be pivotably coupled at the other end to the wheel support member.

Further, in the vehicle suspension arm according to the aspect of the invention, the respective arm members may include regions where the cross-sectional shape is constant at least between the one end and the other end, and the pair of the arm members may be spaced apart from each other and disposed parallel to each other in the regions where cross-sectional shape is constant.

According to the vehicle suspension arm according to the foregoing aspect of the invention, the respective arm members have regions of the constant cross-sectional shape at least between one end and the other end, and the pair of the arm members are spaced apart from each other and disposed parallel to each other in the regions of the constant cross-sectional shape. Therefore, the shapes of the pair of the arm members and the distance between the arms can be simplified in comparison with a case where the respective arm members do not have the regions of the constant cross-sectional shape.

Further, in the vehicle suspension arm according to the aspect of the invention, the cross-sectional shapes may be constant along an entire length of the respective arm members, and the pair of the arm members may be spaced apart from each other and disposed parallel to each other along the entire length of the arm members.

According to the vehicle suspension arm according to the foregoing aspect of the invention, the respective arm members have the constant cross-sectional shape along the entire length thereof, and the pair of the arm members are spaced apart from each other and disposed parallel to each other along the entire length thereof. Therefore, the shapes of the pair of the arm members and the distance between the arms can be simplified along the entire length thereof, and the pair of the arm members can be manufactured with ease and at low cost from, for example, an inexpensive extruded material or the like.

Further, in the vehicle suspension arm according to the aspect of the invention, the respective arm members may include cross-section change regions in which distances between the arm members and an instantaneous center gradually increase in a direction from one side of the one end and the other end toward the other side between the one end and the other end, and the pair of the arm members are separated by a distance that gradually increases from the one side toward the other side in the cross-section change regions.

According to the vehicle suspension arm according to the foregoing aspect of the invention, the respective arm members have the cross-section change regions in which the distances between the arm members and the instantaneous center gradually increase in the direction from one side of one end and the other end toward the other side between one end and the other end, and the pair of the arm members form therebetween the gap that gradually increases in the direction from one side toward the other side in the cross-section change regions. Therefore, the cross-sectional shapes of the respective arm members and the gap therebetween can be changed in the direction from one side of one end and the other end toward the other side, and the degree of freedom in the form of the suspension arm can be enhanced in comparison with a case where the cross-sectional shapes of the respective arm members between one end and the other end are constant.

Further, in the vehicle suspension arm according to the aspect of the invention, the suspension arm may include a shock absorber coupling portion between the one end and the other end, and the pair of the arm members may be connected to each other by two connection plates that are spaced apart from each other in a range between the one end and the shock absorber coupling portion, and have closed cross-sectional shapes in the range.

According to the vehicle suspension arm according to the foregoing aspect of the invention, the suspension arm has the shock absorber coupling portion between one end and the other end, and the pair of the arm members are connected to each other by the two connection plates that are spaced apart from each other in the range between one end and the shock absorber coupling portion, and have the closed cross-sectional shapes in the range. Therefore, the torsional rigidity of the suspension arm in the range can be enhanced in comparison with a case where the pair of the arm members are not connected by the two connection plates. Thus, the amount of torsional deformation of the suspension arm in the shock absorber coupling portion can be reduced when the suspension arm pivots as a result of the bound and rebound of wheels. Accordingly, the bending stress applied to the shock absorber can be reduced, and the amount of change in frictional force between a cylinder and a piston can be reduced.

Further, in the vehicle suspension arm according to the aspect of the invention, one of the connection plates may connect upper edges of the pair of the arm members in a vehicle vertical direction to each other, and the other of the connection plates may connect lower edges of the pair of the arm members in the vehicle vertical direction to each other.

According to the vehicle suspension arm according to the foregoing aspect of the invention, one of the connection plates connects the upper edges of the pair of the arm members to each other, and the other of the connection plates connects the lower edges of the pair of the arm members to each other. Therefore, the torsional rigidity of the suspension arm can be more effectively enhanced than in a case where those regions of the pair of the arm members which are different from the upper edges and the lower edges in the vehicle vertical direction are connected to each other by the connection plates.

Further, in the vehicle suspension arm according to the aspect of the invention, the pair of the arm members may have cross-sectional shapes in which both ends of each of the respective arm members opens to the other side of the centerline side.

Further, in the vehicle suspension arm according to the aspect of the invention, the cross-sectional shape of the pair of the arm members may be symmetrical with respect to a reference line extending past the centerline in a direction in which the pair of the arm members are spaced apart from each other.

Further, in the vehicle suspension arm according to the aspect of the invention, the cross-sectional shapes of the pair of the arm members may each have a flat main body portion and flange portions that protrude from each edge of the main body portion.

Further, in the vehicle suspension arm according to the aspect of the invention, the suspension arm may be pivotably coupled at the one end to the vehicle body around a pivot axis, and the pivot at the one end may intersect with the centerline at right angle thereto.

Further, in the vehicle suspension arm according to the aspect of the invention, the suspension arm may be pivotably coupled at the other end to the wheel support member around a pivot axis, and the pivot axis at the other end may intersect with the centerline at right angle thereto.

Further, in the vehicle suspension arm according to the aspect of the invention, the suspension arm may be pivotably coupled at the one end to the vehicle body around a pivot axis, and may be pivotably coupled at the other end to the wheel support member around a pivot axis, and the pivot axis at the one end and the pivot axis at the other end may intersect with the centerline at right angle thereto and extend parallel to each other.

Further, in the vehicle suspension arm according to the aspect of the invention, the shear centers of the pair of the arm members may be collinear with the centerline over an entire length of the suspension arm.

Further, in the vehicle suspension arm according to the aspect of the invention, the shear centers of the arm members may be equidistantly spaced apart from each other at the centerline over an entire length of the suspension arm.

Further, in the vehicle suspension arm according to the aspect of the invention, the suspension arm may be pivotably coupled at the one end to the vehicle body around a pivot axis, and the pivot axis at the one end may intersect with the centerline at right angle thereto, and intersect with two lines connecting the shear centers of the respective arm members.

Further, in the vehicle suspension arm according to the aspect of the invention, the suspension arm may be pivotably coupled at the other end to the wheel support member around a pivot axis, and the pivot axis at the other end may intersect with the centerline at right angle thereto, and intersect with two lines connecting the shear centers of the respective arm members.

Further, in the vehicle suspension arm according to the aspect of the invention, the cross-sectional shapes of the pair of the pair of the arm members may have establishing a mirror image relationship with each other along an entire length of the suspension arm.

Further, in the vehicle suspension arm according to the aspect of the invention, the pair of the arm members may be integrally connected at the one end and at the other end to each other through connection means provided respectively at the inner end and the outer end.

Further, in the vehicle suspension arm according to the aspect of the invention, the vehicle body-side coupling means may include a rubber bush device.

Further, in the vehicle suspension arm according to the aspect of the invention, the pair of the arm members may have, at the one end, cylindrical portions matching each other, and the rubber bush device may have an outer cylinder press-fitted in the cylindrical portions of the pair of the arm member to be fixed thereby to the one end of each of the pair of the arm members.

Further, in the vehicle suspension arm according to the aspect of the invention, the wheel support member-side coupling means may include a rubber bush device.

Further, in the vehicle suspension arm according to the aspect of the invention, the pair of the arm members may have, at the other end, cylindrical portions matching each other, and the rubber bush device may have an outer cylinder press-fitted in the cylindrical portions of the pair of the arm members to be fixed thereby to the other end of each of the pair of the arm members.

Further, in the vehicle suspension arm according to the aspect of the invention, the suspension arm may have a stabilizer link coupling portion at a position between the one end and the other end, and the pair of the arm members may have cross-sections that are perpendicular to the centerline and a cross-sections area of the cross-sections is greatest at the stabilizer link coupling portion.

### BRIEF DESCRIPTION OF THE DRAWINGS

The foregoing and/or further objects, features and advantages of the invention will become more apparent from the following description of example embodiments with reference to the accompanying drawings, in which like numerals are used to represent like elements and wherein:

FIG. 1 is a plan view showing a vehicle suspension arm according to a first embodiment of the invention;

FIG. 2 is a front view showing one of arm members according to the first embodiment of the invention;

FIG. 3 is an enlarged cross-sectional view taken along a line in FIG. 1, showing a vehicle body-side coupling structure;

FIG. 4 is an enlarged cross-sectional view taken along a line IV-IV in FIG. 1, showing a wheel support member-side coupling structure;

FIG. 5 is a plan view showing the second embodiment of a vehicle suspension arm according to the invention;

FIG. 6 is a front view showing one of arm members according to the second embodiment of the invention;

FIG. 7 is an enlarged cross-sectional view taken along a line VII-VII in FIG. 5, showing a coupling structure of a stabilizer link;

FIG. 8 is a perspective view showing in a simplified manner the third embodiment of a vehicle suspension arm according to the invention;

FIG. 9 is a cross-sectional view showing in a simplified manner how a centerline and a shear center are positionally related to an arm member in a suspension arm according to the related art;

FIG. 10 is a perspective view showing in a simplified manner elastic deformation of the arm member in a case where a torsional stress is applied to the suspension arm according to the related art shown in FIG. 9;

FIG. 11 is a cross-sectional view showing in a simplified manner how a centerline and shear centers are positionally related to arm members in a suspension arm constructed according to the invention;

FIG. 12 is a perspective view showing in a simplified manner elastic deformation of the arm members when a torsional stress is applied to the suspension arm shown in FIG. 11;

FIG. 13 is a cross-sectional view showing in a simplified manner a positional relationship in which lines connecting the shear centers of the pair of the arm members do not match the centerline but are located on the same side as the centerline with respect to main body portions respectively;

FIG. 14 is a cross-sectional view showing in a simplified manner a positional relationship in which the lines connecting the shear centers of the pair of the arm members are located on the other side of the centerline with respect to the main body portions respectively;

FIG. 15 is an illustrative view showing a suspension for the rear wheels of a vehicle equipped with a suspension arm according to a comparative example, which is constructed in the same manner as a suspension arm according to the third embodiment of the invention except in that an upper lid member and a lower lid member are not provided, as viewed from an outboard side of the vehicle; and

FIG. 16 is an illustrative view showing a suspension for rear wheels of a vehicle equipped with the suspension arm according to the third embodiment of the invention, as viewed from an outboard side of the vehicle.

### DETAILED DESCRIPTION OF EMBODIMENTS

The embodiments of the invention will be described in detail with reference to the drawings.

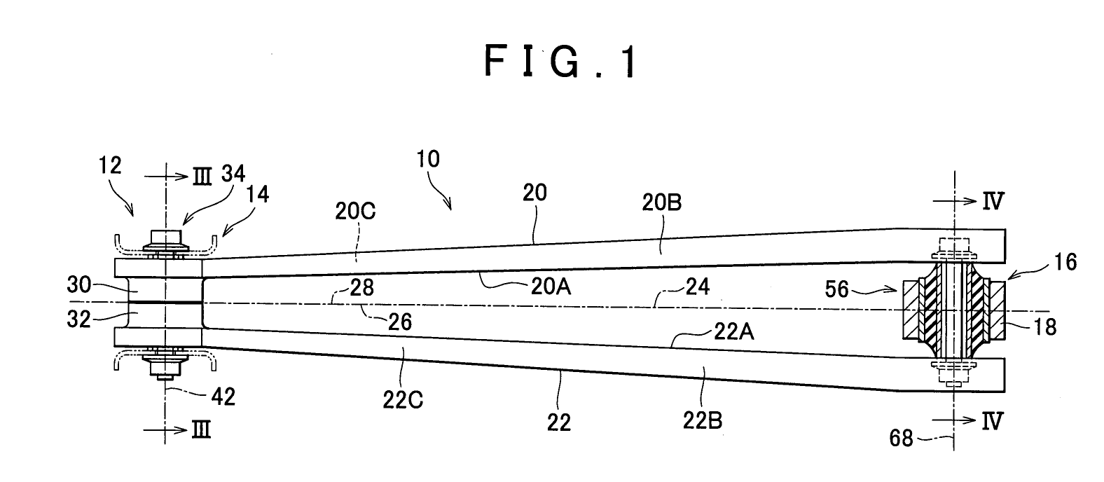

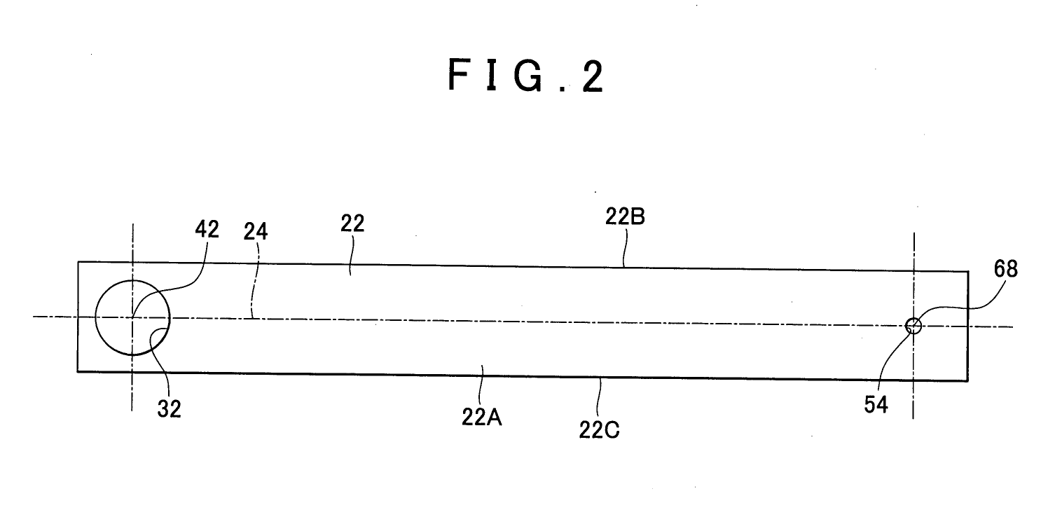

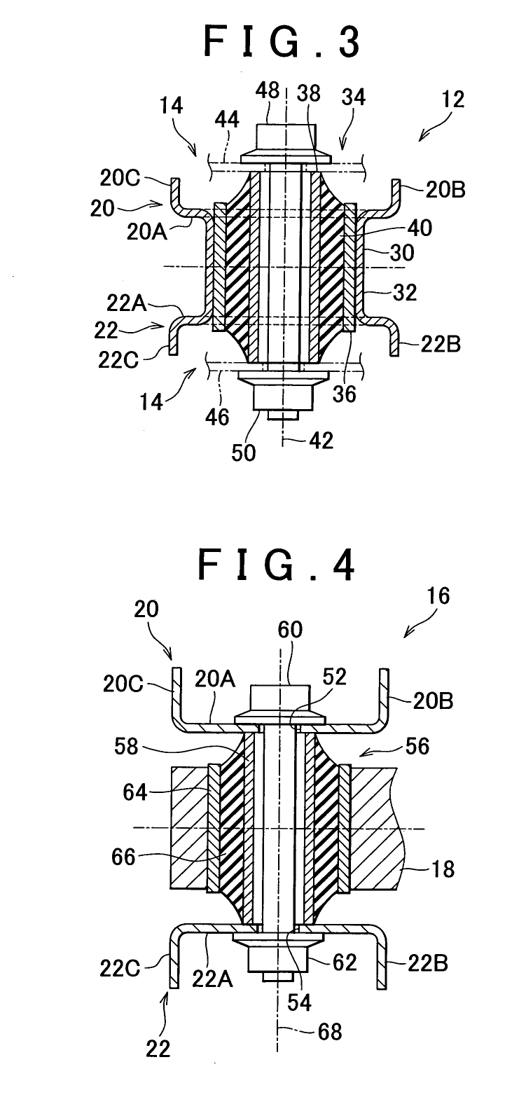

FIG. 1 is a plan view showing the first embodiment of a vehicle suspension arm according to the invention. FIG. 2 is a front view showing one of arm members according to the first embodiment of the invention. FIG. 3 is an enlarged cross-sectional view taken along a line in FIG. 1, showing a vehicle body-side coupling structure. FIG. 4 is an enlarged cross-sectional view taken along a line IV-IV in FIG. 1, showing a wheel support member-side coupling structure.

In these drawings, the overall suspension arm is denoted by a reference numeral 10. The suspension arm 10 is pivotally attached at one end (inner end) to a vehicle body 14 through a vehicle body-side coupling structure 12, and is pivotally attached at the other end (outer end) thereof to a wheel support member (axle carrier) 18 through a wheel support member-side coupling structure 16.

The suspension arm 10 includes a pair of arm members 20 and 22 that extend rectilinearly and are spaced apart from each other at least in a horizontal direction, and the arm members 20 and 22 define a rectilinear centerline 24 of the suspension arm 10 therebetween with the cooperation with each other. The arm members 20 and 22 have cross-sectional shapes opening to the other side of the centerline 24 side (away from each other) (that is, both ends thereof protrude in the same direction). The arm members 20 and 22 are equal in size to each other, and the cross-sectional shapes of the arm members 20 and 22 establish a mirror image relationship with each other on both sides of a virtual plane extending past the centerline 24 and perpendicularly to the sheet of FIG. 1.

The arm member 20 has a main body portion 20A that extends substantially along a vehicle vertical direction, and flange portions 20B extending perpendicularly to the main body portion 20A integrally with an upper edge of the main body portion 20A in the vehicle vertical direction and flange portions 20C extending perpendicularly to the main body portion 20A integrally with a lower edge of the main body portion 20A in the vehicle vertical direction. The main body portion 20A has a constant width along an entire length thereof, namely, assumes a generally oblong shape. The flange portions 20B and 20C are equal in width to each other at an arbitrary position along the centerline 24. Accordingly, the cross-sectional shape of the arm member 20 is symmetrical with respect to a reference line extending past the centerline 24 and in a direction in which the pair of the arm members 20 and 22 are spaced apart from each other.

Similarly, the arm member 22 has a main body portion 22A that extends substantially along the vehicle vertical direction, and flange portions 22B and 22C extending perpendicularly to the main body portion 22A integrally with an upper edge of the main body portion 22A in the vehicle vertical direction and a lower edge of the main body portion 22A in the vehicle vertical direction. The main body portion 22A has a constant width along an entire length thereof, namely, assumes a generally oblong shape. The flange portions 22B and 22C are equal in width to each other at an arbitrary position along the centerline 24. Accordingly, the cross-sectional shape of the arm member 22 is also symmetrical with respect to a reference line extending past the centerline 24 and in a direction in which the pair of the arm members 20 and 22 are spaced apart from each other.

Especially in the first embodiment of the invention illustrated in the drawings, the main body portions 20A and 22A of the arm members 20 and 22 are parallel to each other at one end and the other end. However, the distance between the main body portions 20A and 22A gradually increases in the direction from one end toward the other end in a region between one end and the other end. Further, the width of the flange portions 20B, 20C, 22B, and 22C is constant at one end and the other end, but gradually increases in the direction from one end toward the other end in the region between one end and the other end.

Owing to the aforementioned construction, although the distance between the arm members 20 and 22 and the cross-sectional areas thereof are not constant along the entire length thereof, shear centers of the arm members 20 and 22 are located on the centerline 24 along the entire length of each arm member 20 and 22. Accordingly, lines 26 and 28, which connect the shear centers of the arm members 20 and 22, are collinear with the centerline 24 along the entire length of the suspension arm 10.

As shown in FIG. 1, cylindrical portion 30 and cylindrical portion 32, which extend perpendicularly to the main body portions 20A and 22A on the other side of the respective flange portions, are formed on the main body portions 20A and 22A of the arm members 20 and 22 at one end thereof, by means of, for example, drawing. That is, the cylindrical portions 30 and 32 extend from the main body portions 20A and 22A respectively in such a manner as to approach each other while matching each other. The cylindrical portions 30 and 32 abut on each other or face each other at tips thereof. An outer tube 36 of a rubber bush device 34 is fixed through press fitting to an inside region of the cylindrical portions 30 and 32.

The rubber bush device 34 is a cylindrical rubber bush device having a rubber bush 40 interposed between the outer cylinder 36 thereof and an inner cylinder 38 thereof, and defines a pivot axis 42 extending perpendicularly to the main body portions 20A and 22A of the arm members 20 and 22 and intersecting with the centerline 24 at right angle thereto. The inner cylinder 38 is disposed between a pair of brackets 44 and 46 of the vehicle body 14, and is mounted to the brackets 44 and 46 by means of holes provided through the brackets 44 and 46, a bolt 48 inserted through the inner cylinder 38, and a nut 50 screwed on the bolt 48.

Thus, the cylindrical portions 30 and 32, the rubber bush device 34, the bolt 48, the nut 50, and the like cooperate with one another to constitute the vehicle body-side coupling structure 12 for pivotably attaching one end of the suspension arm 10 to the vehicle body 14 pivotably around the pivot axis 42. Further, the cylindrical portions 30 and 32 and the outer cylinder 36 of the rubber bush device 34 cooperate with one another to constitute connection means at one end side, which connects one end of the arm member 20 and one end of the arm member 22 to each other.

Holes 52 and 54 are provided through the main body portion 20A at the other end of the arm member 20 and the main body portion 22A at the other end of the arm member 22 respectively, and an inner cylinder 58 of a rubber bush device 56 is disposed between the main body portions 20A and 22A in such a manner as to match the holes 52 and 54. The inner cylinder 58 is mounted to the main body portion 20A at the other end of the arm member 20 and the main body portion 22A at the other end of the arm member 22 by a bolt 60 inserted through the holes 52 and 54 and the inner cylinder 58 and a nut 62 screwed on the bolt 60.

The rubber bush device 56 is also a cylindrical rubber bush device having a rubber bush 66 interposed between the inner cylinder 58 and the outer cylinder 64, and defines a pivot axis 68. The pivot axis 68 also extends perpendicularly to the main body portions 20A and 22A of the arm members 20 and 22, intersects with the centerline 24 at right angle thereto, and is parallel to the pivot axis 42. The outer cylinder 64 is fixed through press-fitting to a hole provided through the wheel support member 18.

Thus, the holes 52 and 54, the rubber bush device 56, the bolt 60, the nut 62, and the like cooperate with one another to constitute the wheel support member-side coupling structure 16 for coupling the other end of the suspension arm 10 to the wheel support member 18 pivotably around the pivot axis 68. Further, the holes 52 and 54, the rubber bush device 56, the bolt 60, the nut 62, and the like cooperate with one another to constitute connection means at the other end side, which connects the other end of the arm member 20 and the other end of the arm member 22 to each other.

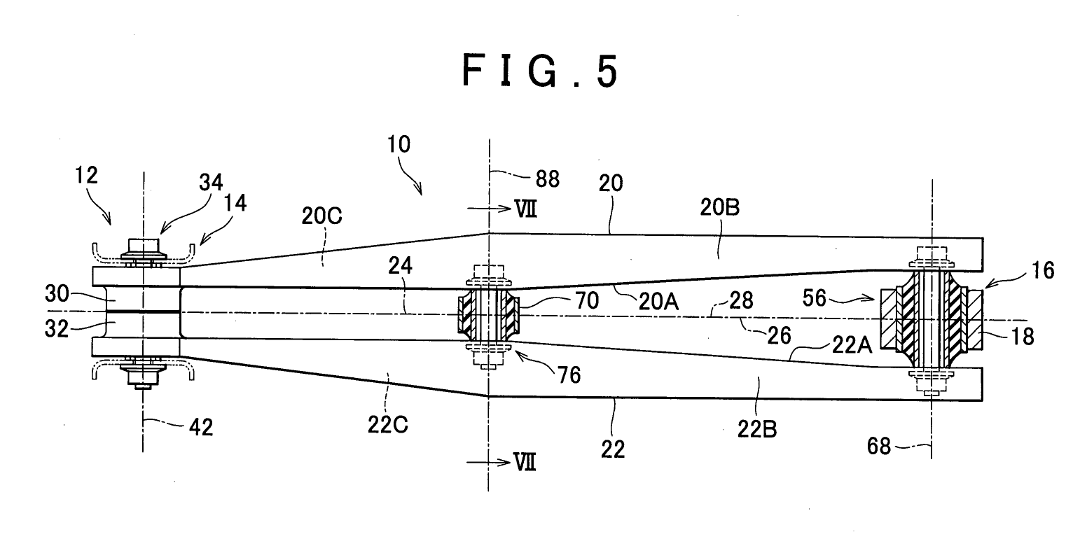

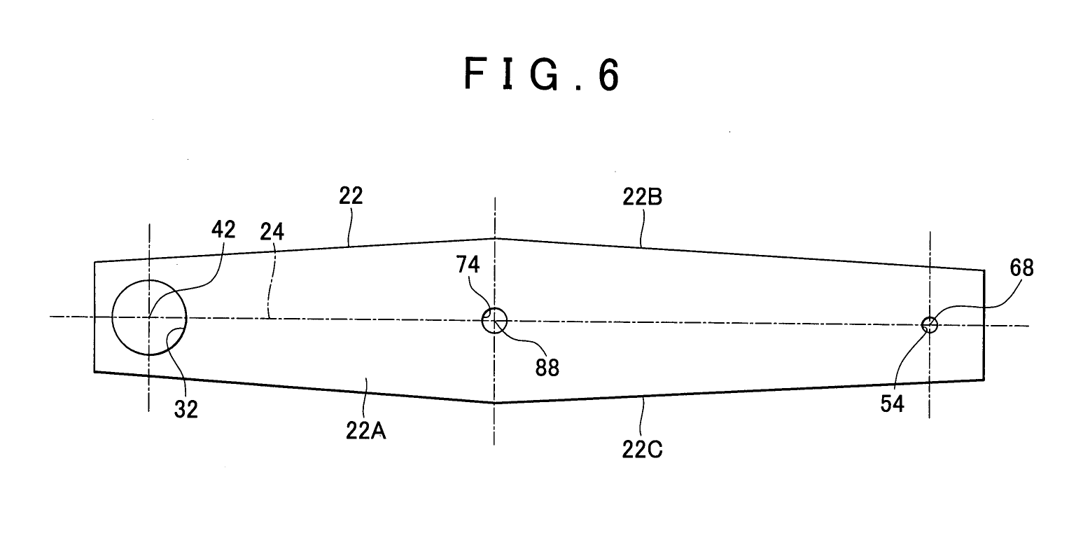

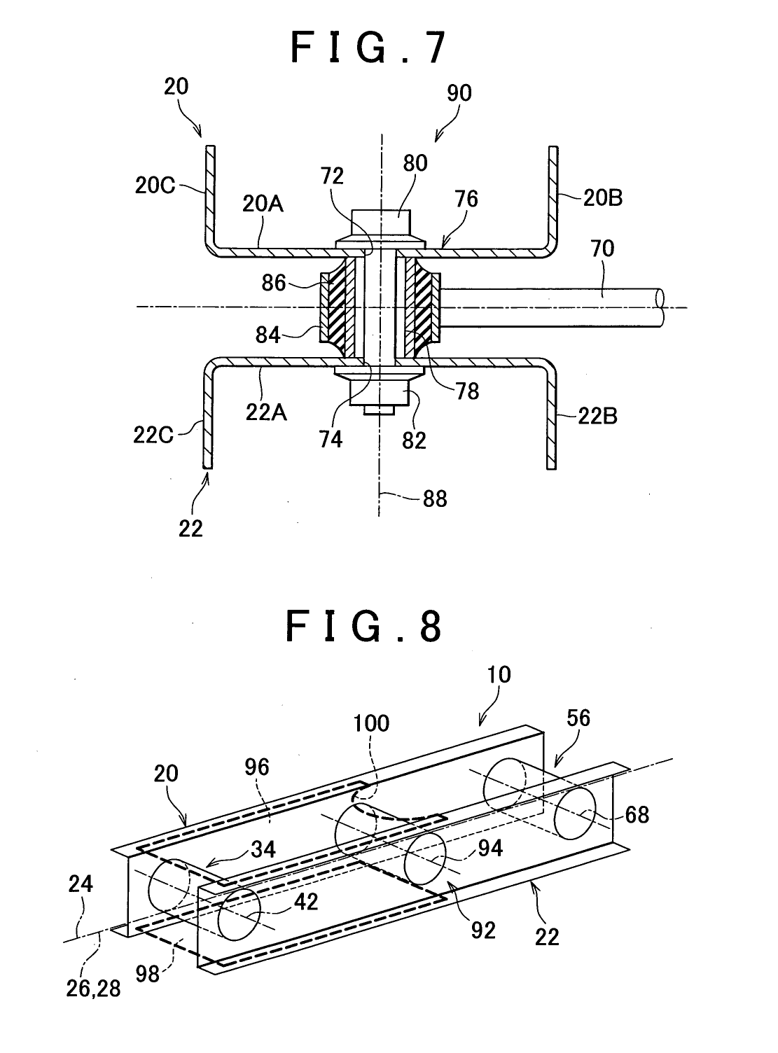

FIG. 5 is a plan view showing the second embodiment of a vehicle suspension arm according to the invention. FIG. 6 is a front view showing one of arm members according to the second embodiment of the invention. FIG. 7 is an enlarged cross-sectional view taken along a line VII-VII in FIG. 5, showing a coupling structure of a stabilizer link. In these drawings, members identical to those shown in FIGS. 1 to 4 are denoted by the same reference symbols as in FIGS. 1 to 4 respectively.

In the second embodiment of the invention, as shown in FIG. 6, the width of the main body portions 20A and 22A of the arm members 20 and 22 is not constant. The width reaches a maximum at a central portion of the suspension arm 10 (in a region to which a stabilizer link 70 is coupled), and gradually decreases in a direction from the central portion toward one end or the other end.

In a region from one end to the central portion, the main body portions 20A and 22A of the arm members 20 and 22 are parallel to each other, and the distance therebetween is constant. However, in a region between the central portion and the other end, the gap between the main body portions 20A and 22A gradually increases in a direction from the central portion toward the other end. Further, the width of the flange portions 20B, 20C, 22B, and 22C gradually increases in the direction from one end toward the central portion in the region between one end and the central portion, and conversely, gradually decreases in the direction from the central portion toward the other end in the region between the central portion and the other end.

With the construction described above, although the distance between the arm members 20 and 22, the cross-sectional area thereof, and the cross-sectional shapes thereof are not constant over the entire length of the arm members 20 and 22, the shear centers of the arm members 20 and 22 are located on the centerline 24 over the entire length the arm members 20 and 22 as in the case of the foregoing first embodiment of the invention. Accordingly, the lines 26 and 28 connecting the shears centers of the arm members 20 and 22 match the centerline 24 along the entire length of the suspension arm 10.

Holes 72 and 74 are provided through the main body portions 20A and 22A of the arm members 20 and 22 at central portions thereof, and an inner cylinder 78 of a rubber bush device 76 is disposed between the main body portions 20A and 22A in such a manner as to match the holes 72 and 74. The inner cylinder 78 is mounted to the main body portions 20A and 22A of the arm members 20 and 22 at the central portions thereof by means of the holes 72 and 74, a bolt 80 inserted through the inner cylinder 78, and a nut 82 screwed on the bolt 80.

The rubber bush device 76 is also a cylindrical rubber bush device having a rubber bush 86 interposed between the inner cylinder 78 and an outer cylinder 84 of the rubber bushing 76, and defines a pivot axis 88. The pivot axis 88 also extends perpendicularly to the main body portions 20A and 22A of the arm members 20 and 22, intersects with the centerline 24 at right angle thereto, and is parallel to the pivot axes 42 and 68. The outer cylinder 84 is fixed to one end of the stabilizer link 70.

Thus, the main body portions 20A and 22A of the arm members 20 and 22 at the central portions thereof, the rubber bush device 76, the bolt 80, the nut 82, and the like cooperate with one another to constitute a coupling structure 90 for pivotally attaching one end of the stabilizer link 70 to the central portion of the suspension arm 10 pivotably around the pivot axis 88. Further, the main body portions 20A and 22A of the arm members 20 and 22 at the central portions thereof, the rubber bush device 76, the bolt 80, the nut 82, and the like cooperate with one another to constitute connection means at the central portion, which connects the central portion of the arm member 20 and the central portion of the arm member 22 to each other.

In the other respects, for example, the relationship in cross-sectional shape between the arm members 20 and 22, the structures of the vehicle body-side coupling structure 12 and the wheel support member-side coupling structure 16, and the like, this second embodiment of the invention is identical to the foregoing first embodiment of the invention.

FIG. 8 is a perspective view showing in a simplified manner the third embodiment of a vehicle suspension arm according to the invention. In FIG. 8, members identical to those shown in FIGS. 1 to 7 are denoted by the same reference symbols as in FIGS. 1 to 7 respectively.

In this third embodiment of the invention, except the cylindrical portions for receiving the rubber bush device 34 at one end (which correspond to the cylindrical portions 30 and 32 in the first embodiment of the invention and the second embodiment of the invention), the arm members 20 and 22 have constant cross-sectional shapes which are identical to each other along the entire length thereof and in which both ends thereof protrude in the same direction. The arm members 20 and 22 are separated from each other and disposed parallel to each other along the entire length of the arm members 20, 22 on both the sides of the centerline 24, and the lines 26 and 28 connecting the shear centers of the arm members 20 and 22 match the centerline 24 over the entire length of the suspension arm 10.

A rubber bush device 92 similar to the rubber bush devices 34 and 56, which are provided on the arm members 20 and 22 at one end thereof and the other end thereof respectively, is disposed between the arm members 20 and 22 at the central portion of the suspension arm 10. Although not shown in detail in FIG. 8, the rubber bush device 92 is mounted to the central portion of the suspension arm 10 by means of an inner cylinder of the rubber bush device 92, a bolt inserted through the main body portions 20A and 22A of the arm members 20 and 22, and a nut screwed on the bolt.

Although not shown in FIG. 8, a mounting eye of a shock absorber at a lower end thereof in the vehicle vertical direction is fitted through press-fitting in an outer cylinder of the rubber bush device 92, and the lower end of the shock absorber in the vehicle vertical direction is coupled to the suspension arm 10 relatively pivotably around an axis 94 of the rubber bush device 92. The axis 94 intersects with the centerline 24 at right angle thereto, and is parallel to the pivot axes 42 and 68 defined by the rubber bush devices 34 and 56 respectively.

Further, as indicated by broken lines in FIG. 8, a flat upper lid member 96 and a flat lower lid member 98 as connection plates are hung across a region between the flange portions 20B and 20C of the arm member 20 and a region between the flange portions 22B and 22C of the arm member 22 respectively in the range between one end of the suspension arm 10 and the central portion of the suspension arm 10. The upper lid member 96 is fixed at both lateral edges thereof to the flange portions 20B and 20C respectively through welding or the like, and the lower lid member 98 is fixed at both lateral edges thereof to the flange portions 22B and 22C respectively through welding or the like. A U-shaped notch 100 for preventing the upper lid member 96 from interfering with the shock absorber that is not shown in FIG. 8 is provided at an end of the upper lid member 96 on the central portion side of the suspension arm 10.

The suspension arm 10 has a closed cross-sectional shape in a region where the upper lid member 96 and the lower lid member 98 are provided. In this region as well, the lines 26 and 28 connecting the shear centers of the arm members 20 and 22 match the centerline 24 of the suspension arm 10. Further, in the other respects, this third embodiment of the invention is identical in construction to the foregoing first embodiment of the invention and the foregoing second embodiment of the invention.

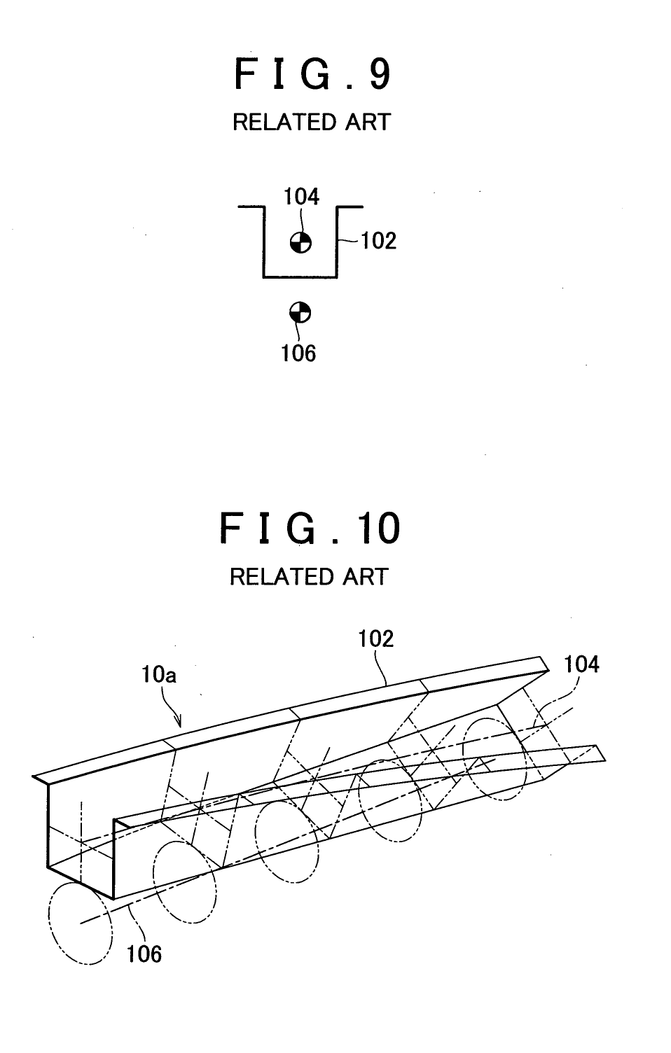

FIG. 9 is a cross-sectional view showing in a simplified manner how a centerline and a shear center are positionally related to an arm member in a suspension arm according to the related art, which has a cross-section in which both ends thereof protrude in the same direction. FIG. 10 is a perspective view showing in a simplified manner elastic deformation of the arm member in a case where a torsional stress is applied to the suspension arm according to the related art shown in FIG. 9.

As shown in FIG. 9, in a suspension arm 10a according to the related art, which has a cross-sectional shape in which both ends thereof protrude in the same direction, while a centerline 104 is located inside a cross-sectional shape of an arm member 102 in which both ends thereof protrude in the same direction (in a direction in which both the ends protrude), a line 106 connecting shear centers is located outside the cross-sectional shape of the arm member 102 in which both the ends thereof protrude in the same direction (reversely to the direction in which both the ends protrude). Therefore, as shown in FIG. 10, when a torsional stress is applied to the suspension arm 10a, the arm member 102 undergoes torsional deformation around the line 106 connecting the shear centers, and the centerline 104 is twisted around the line 106 connecting the shear centers. As a result, the suspension arm 10a undergoes bending deformation. Accordingly, in the suspension arm according to the related art which has the cross-sectional shape in which both the ends thereof protrude in the same direction, when a torsional stress is applied to the suspension arm, the geometry of a suspension unnaturally changes, or an excessive frictional force acts among members of the suspension. Thus, the suspension arm is hindered from smoothly pivoting in some cases.

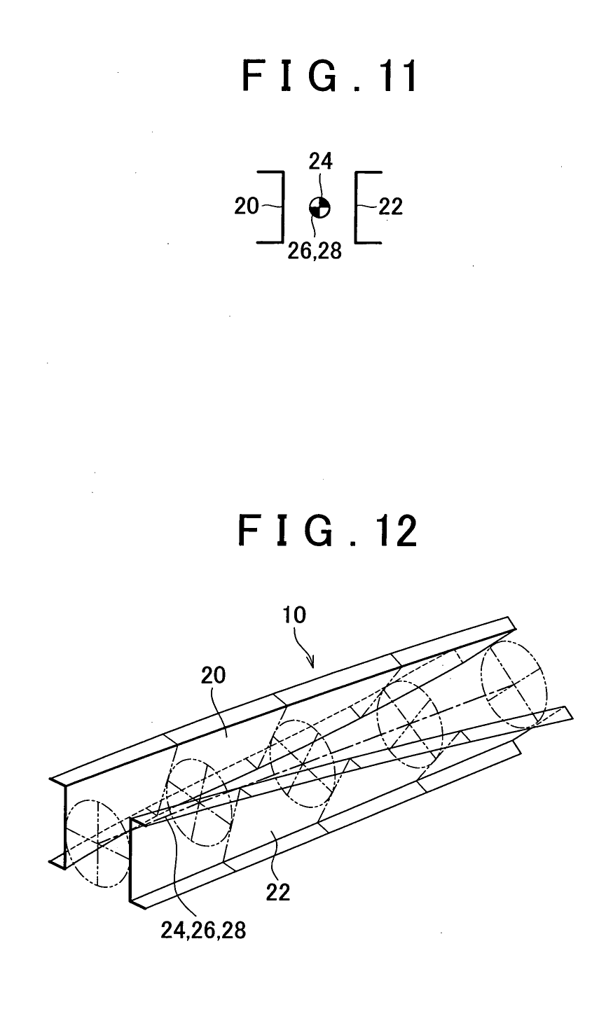

FIG. 11 is a cross-sectional view showing in a simplified manner how a centerline and shear centers are positionally related to arm members in a suspension arm constructed according to the invention. FIG. 12 is a perspective view showing in a simplified manner elastic deformation of the arm members in a case where a torsional stress is applied to the suspension arm shown in FIG. 11.

In the suspension arm 10 shown in FIG. 11, as is the case with the foregoing first to third embodiments of the invention, the pair of the arm members 20 and 22 have cross-sectional shapes opening reversely to each other, and have the centerline 24 at a midpoint therebetween. The lines 26 and 28 connecting the shear centers of the pair of the arm members 20 and 22 match the centerline 24.

As shown in FIG. 12, when a torsional stress is applied to the suspension arm 10 constructed according to the invention, the arm members 20 and 22 undergo torsional deformation around the same centerline 24 as the lines 26 and 28 connecting the shear centers of the arm members 20 and 22. Therefore, the arm members 20 and 22 do not undergo bending deformation. Thus, according to the foregoing first to third embodiments of the invention, the amount of unnatural change in the geometry of the suspension and the frictional force among the members of the suspension can be reduced when a torsional force is applied to the suspension arm, in comparison with the suspension arm according to the related art. In consequence, the smooth pivoting of the suspension arm can be ensured.

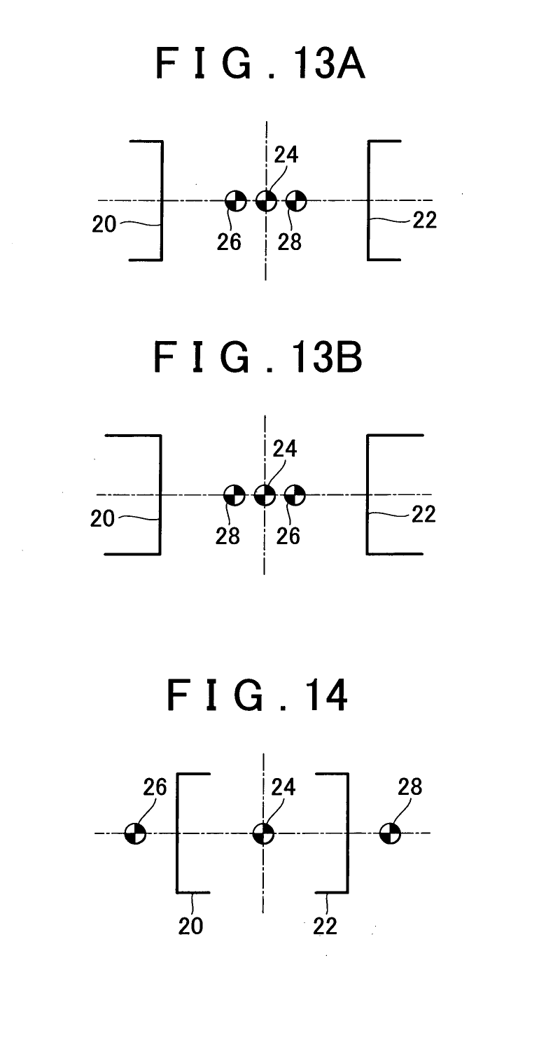

In each of the foregoing embodiments of the invention, the shear centers of the pair of the arm members 20 and 22 are located on the centerline 24, and the lines 26 and 28 connecting the shear centers match the centerline 24. However, as shown in, for example, FIGS. 13A and 13B, when the shear centers of the pair of the arm members 20 and 22 are located on the centerline 24 side with respect to the main body portions 20A and 22A respectively, it is not absolutely required that the shear centers be located on the centerline 24 at least in part of the region between one end of the suspension arm 10 and the other end thereof. Accordingly, the lines 26 and 28 connecting the shear centers are not required to match the centerline 24.

When the lines 26 and 28 connecting the shear centers are positionally related to the centerline 24 as shown in FIGS. 13A and 13B, the amount of unnatural change in the geometry of the suspension and the frictional force between the members of the suspension can be reduced when a torsional stress is applied to the suspension arm 10, in comparison with a case where the line 106 connecting the shear centers is positionally related to the centerline 104 as shown in FIG. 9 (in the case of the related art). As a result, the smooth pivoting of the suspension arm can be ensured. Further, when the lines 26 and 28 connecting the shear centers are positionally related to the centerline 24 as shown in FIGS. 13A and 13B, smoother torsional deformation of the suspension arm can be ensured when a torsional stress is applied to the suspension arm, than in a case where the lines 26 and 28 connecting the shear centers are positionally related to the arm members 20 and 22 as shown in FIG. 14.

Further, when the lines 26 and 28 connecting the shear centers are positionally related to the centerline 24 as shown in FIGS. 13A and 13B, the distances between the lines 26 and 28 connecting the shear centers and the centerline 24 may be different from each other at an arbitrary position along the length of the suspension arm. However, it is preferable that these distances be equal to each other. It is preferable that the lines 26 and 28 connecting the shear centers and the centerline 24 be located on the same virtual plane.

Further, according to each of the foregoing embodiments of the invention, the pivot axis 42 of the vehicle body-side coupling structure 12 and the pivot axis 68 of the wheel support member-side coupling structure 16 extend perpendicularly to the main body portions 20A and 22A of the arm members 20 and 22 respectively, intersect with the centerline 24 at right angle thereto, and are parallel to each other. Therefore, the pivoting of the suspension arm 10 with respect to the vehicle body 14 and the wheel support member 18 resulting from the bound and rebound of the wheels can be made smoother than in a case where, for example, the pivot axes 42 and 68 do not intersect with the centerline 24 at right angle thereto or are not parallel to each other.

Especially, according to the foregoing second embodiment of the invention, the pivot axis 88 of the coupling structure 90, which pivotally attaches one end of the stabilizer link 70 to the central portion of the suspension arm 10, intersects with the centerline 24 at right angle thereto and is parallel to the pivot axes 42 and 68. Therefore, the pivoting of the stabilizer link 70 with respect to the suspension arm 10 resulting from the bound and rebound of the wheels can be made smoother than in a case where, for example, the pivot axis 88 does not intersect with the centerline 24 at right angle thereto or is not parallel to the pivot axes 42 and 68. As a result, a force of a stabilizer can be effectively transmitted to the suspension arm 10.

By the same token, according to the foregoing third embodiment of the invention, the axis 94 of the rubber bush device 92 intersects with the centerline 24 at right angle thereto and is parallel to the pivot axes 42 and 68. Therefore, the pivoting of the shock absorber with respect to the suspension arm 10 resulting from the bound and rebound of the wheels can be made smoother than in a case where, for example, the axis 94 does not intersect with the centerline 24 at right angle thereto or is not parallel to the pivot axes 42 and 68. As a result, a damping force of the shock absorber can be effectively transmitted to the suspension arm 10.

Further, according to each of the foregoing embodiments of the invention, the pair of the arm members 20 and 22 have cross-sectional shapes that establish a mirror relationship with each other and are axisymmetrical to each other with respect to the reference line extending past the centerline 24 and perpendicularly to the direction in which the arm members are spaced apart from each other. Accordingly, the amount of surplus torsional deformation of the suspension arm can be reduced when the suspension arm 10 receives a stress in the direction along the virtual plane or in the direction perpendicular thereto, in comparison with a case where the pair of the arm members do not have axisymmetrical cross-sectional shapes that establish a mirror image relationship with each other as described above. Further, the amount of surplus bending deformation of the suspension arm can be reduced when the suspension arm 10 receives a compressive stress or a tensile stress along the longitudinal direction thereof, in comparison with a case where the pair of the arm members 20 and 22 do not have axisymmetrical cross-sectional shapes that establish a mirror image relationship with each other.

Further, according to each of the foregoing embodiments of the invention, the cross-sectional shapes of the pair of the arm members 20 and 22 are symmetrical to each other with respect to the reference line extending past the centerline 24 and in the direction in which the pair of the arm members 20 and 22 are spaced apart from each other. Accordingly, the bending rigidities and strengths of the suspension arm 10 in both the directions perpendicular to the reference line can be made equal to each other in comparison with a case where the cross-sectional shapes of the pair of the arm members 20 and 22 are not symmetrical to each other with respect to the reference line.

Further, in each of the foregoing embodiments of the invention, the arm members 20 and 22 are integrally connected at one end to each other by the vehicle body-side coupling structure 12. Therefore, the handling of the suspension arm 10 and the mounting of the suspension arm 10 to the vehicle can be carried out more easily and more efficiently than in a case where the arm members 20 and 22 are not connected to each other.

Further, according to each of the foregoing embodiments of the invention, the outer cylinder 36 of the rubber bush device 34 is fixed through press-fitting in the cylindrical portions 30 and 32 that are provided on the arm members 20 and 22 at one end thereof respectively, and the arm members 20 and 22 are thereby integrally connected to each other. Accordingly, the rubber bush device 34, the cylindrical portions 30 and 32, and the like constitute part of the vehicle body-side coupling structure 12, and also function as the connection means for integrally connecting the arm members 20 and 22 to each other. Therefore, the structure of the suspension arm 10 on one end side thereof can be simplified, and the number of components can be reduced, in comparison with a structure in which the connection means is completely independent of the vehicle body-side coupling structure 12.

Further, according to the foregoing first and second embodiments of the invention, the distance between the main body portions 20A and 22A of the arm members 20 and 22 at one end thereof and the other end thereof may be different from each other. Therefore, the degree of freedom in the structures of the coupling portion on the vehicle body side and the coupling portion on the wheel support member side, to which the suspension arm 10 is coupled, can be enhanced in comparison with the case of the foregoing third embodiment of the invention.

Further, according to the foregoing second embodiment of the invention, the width of the main body portions 20A and 22A of the arm members 20 and 22 is at its maximum at the central portion of the suspension arm 10 to which the stabilizer link 70 is coupled, and gradually decreases in the direction from the central portion toward one end or the other end. In consequence, the width of the flange portions 20B, 20C, 22B, and 22C gradually decreases in the direction from the central portion toward one end or the other end.

Accordingly, while ensuring a situation in which the lines 26 and 28 connecting the shear centers of the arm members 20 and 22 match the centerline 24 along the entire length of the suspension arm 10, the strength and bending rigidity of the suspension arm 10 at the central portion thereof can be enhanced. Thus, the mounting strength of the stabilizer link 70 can be enhanced, and the amount of elastic deformation resulting from a stress received by the suspension arm 10 from the stabilizer link 70 can be reduced in comparison with, for example, the cases of the first embodiment of the invention and the third embodiment of the invention.

Further, according to the foregoing third embodiment of the invention, except the cylindrical portions receiving the rubber bush device 34 at one end, the arm members 20 and 22 have constant cross-sectional shapes which are identical to each other along the entire length thereof and in which both the ends protrude in the same direction. Therefore, the arm members 20 and 22 can be manufactured from a single type of material. Further, an inexpensive extruded material or the like can be used as the material for the arm members. Therefore, the suspension arm 10 can be manufactured more efficiently and at lower cost than in the cases of the foregoing first embodiment of the invention and the foregoing second embodiment of the invention.

Further, according to the foregoing third embodiment of the invention, the flat upper lid member 96 and the flat lower lid member 98 are hung across the region between the flange portions 20B and 20C of the arm member 20 and the region between the flange portions 22B and 22C of the arm member 22 respectively, and are fixed to the corresponding flange portions respectively.

Accordingly, the suspension arm 10 has a closed cross-sectional shape in the region where the upper lid member 96 and the lower lid member 98 are provided. The torsional rigidity of the suspension arm 10 between one end and the rubber bush device 92 can almost be, for example, centupled in comparison with a case where the upper lid portion 96 and the lower lid portion 98 are not provided. Thus, the amount of torsional deformation at half of one end side of the suspension arm 10 can be reduced, and the support strength of the shock absorber at the lower end thereof in the vehicle vertical direction can be enhanced.

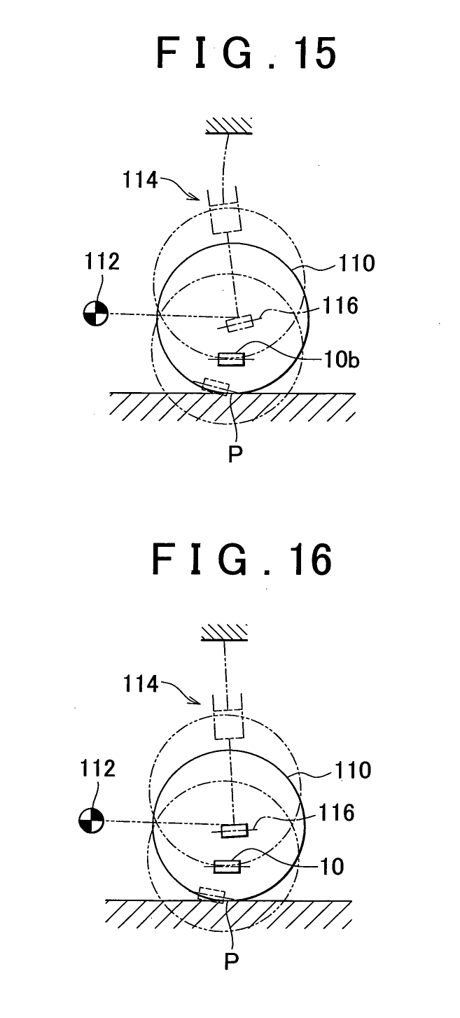

For example, FIG. 15 is an illustrative view showing a suspension for rear wheels of a vehicle mounted with a suspension arm 10b according to a comparative example, which is constructed in the same manner as the suspension arm 10 according to the foregoing third embodiment of the invention except in that the upper lid member 96 and the lower lid member 98 are not provided, as viewed from an outboard side of the vehicle. FIG. 16 is an illustrative view showing a suspension for rear wheels of a vehicle mounted with the suspension arm 10 according to the foregoing third embodiment of the invention, as viewed from an outboard side of the vehicle.

In FIGS. 15 and 16, a rear wheel of the vehicle is denoted by a reference numeral 110. An instantaneous center of the rear wheel 110 resulting from the bound and rebound of the rear wheel 110, in a narrow sense, an instantaneous center of the wheel support member (not shown) is denoted by a reference numeral 112. As shown in FIGS. 15 and 16, the instantaneous center 112 of the rear wheel 110 is set in front of and above a grounding point P of the rear wheel 110 with respect to the vehicle, with a view to reducing the amount of lift at the time of braking of the vehicle.

Thus, in the case of the suspension arm 10b, which is likely to be twisted around the centerline, when the rear wheel 110 rotates around the instantaneous center 112 thereof as a result of the bound and rebound of the rear wheel 110 as shown in FIG. 15, an outer end of the suspension arm 10b rotates together with the rear wheel 110 around the instantaneous center 112. Therefore, the angle formed by a pivot axis 116 of a coupling portion of a shock absorber 114 at a lower end thereof in a vehicle vertical direction with respect to a direction in which the shock absorber 114 extends greatly changes. Thus, a bending stress is applied to the shock absorber 114 and causes a great change in frictional force between a cylinder and a piston.

On the other hand, according to the foregoing third embodiment of the invention, even when the outer end of the suspension arm 10 rotates together with the rear wheel 110 around the instantaneous center 112 as a result of the bound and rebound of the rear wheel 110 as shown in FIG. 16, the torsional amount of the suspension arm 10 in a region to which the lower end of the shock absorber 14 in the vehicle vertical direction is coupled is small. Therefore, the angle formed by the pivot axis 116 of the coupling portion at the lower end of the shock absorber 114 with respect to the direction in which the shock absorber 114 extends does not change as greatly as shown in FIG. 15. Accordingly, the bending stress applied to the shock absorber 114 can be reduced, and the amount of change in frictional force between the cylinder and the piston can be reduced.

Although the specific embodiments of the invention have been described above in detail, the invention is not limited to the foregoing embodiments thereof. A variety of other embodiments are applicable within the scope of the invention.

For example, in each of the foregoing embodiments of the invention, the arm members 20 and 22 are integrally connected at one end to each other by the rubber bush device 34 of the vehicle body-side coupling structure 12. However, the arm members 20 and 22 may not be integrally connected at one end to each other either, as is the case with the other end in each of the embodiments of the invention. In that case, it is preferable that the arm members 20 and 22 be pivotably coupled at one end to the vehicle body while being integrated with each other by the coupling structure such as the vehicle body-side coupling structure 12, and that the arm members 20 and 22 be pivotably coupled at the other end to the wheel support member while being integrated with each other by the coupling structure such as the wheel support member-side coupling structure 16.

Further, the arm members 20 and 22 may be integrally connected at the other end to each other instead of being integrally connected at one end to each other. In this case, it is preferable that the arm members 20 and 22 be integrally connected at the other end to each other in a structure similar to that of the integral coupling at one end by the rubber bush device 34 of the vehicle body-side coupling structure 12.

Further, the arm members 20 and 22 may be integrally connected at the other end as well as one end to each other. In that case, the suspension arm 10 can be handled as a single suspension member. Therefore, the suspension arm 10 can be mounted to the vehicle more easily and more efficiently than in the case of each of the foregoing embodiments of the invention. In this case as well, it is preferable that the arm members 20 and 22 be integrally connected at the other end to each other in a structure similar to that of the integral coupling at one end by the rubber bush device 34 of the vehicle body-side coupling structure 12.

Further, in each of the foregoing embodiments of the invention, the rubber bush device 34 of the vehicle body-side coupling structure 12 cooperates with the cylindrical portions 30 and 32 of the arm members 20 and 22 to function as coupling means for pivotably coupling one end of the suspension arm 10 to the vehicle body 14 and also as connection means for integrally connecting one end of the arm member 20 and one end of the arm member 22 to each other. However, the coupling means and the connection means may be independent of each other.

Further, in each of the foregoing embodiments of the invention, the coupling means is composed of the cylindrical portions 30 and 32 of the arm members 20 and 22 and the rubber bush device 34 press-fitted therein. However, the connection means may have a structure other than that of the embodiments of the invention as long as the arm members 20 and 22 are thereby integrally connected to each other.

Further, in each of the foregoing embodiments of the invention, the arm members 20 and 22 have the cross-sectional shape in which both the ends thereof protrude in the same direction. However, the cross-sectional shapes of the arm members 20 and 22 may be arbitrary as long as the arm members 20 and 22 cooperate with each other to define the centerline 24 of the suspension arm 10 therebetween and the shear centers of the arm members 20 and 22 are located on the centerline 24 side, preferably on the centerline 24 with respect to the arm members respectively.

Further, in each of the foregoing embodiments of the invention, the arm members 20 and 22 have the cross-sectional shapes that establish a mirror image relationship with each other and are axisymmetrical to each other with respect to the virtual line extending past the centerline 24 and perpendicularly to the direction in which the arm members are spaced apart from each other. However, the cross-sectional shapes of the arm members 20 and 22 may not establish a mirror image relationship with each other or be axisymmetrical to each other with respect to the virtual line extending past the centerline 24 and perpendicularly to the direction in which the arm members are spaced apart from each other.

Further, in each of the foregoing embodiments of the invention, the vehicle body-side coupling means for pivotably coupling the arm members 20 and 22 at one end thereof to the vehicle body 14 and the wheel support member-side coupling means for pivotably coupling the arm members 20 and 22 at the other end thereof to the wheel support member 18 include the rubber bush devices 34 and 56 respectively. However, at least one of the vehicle body-side coupling means and the wheel support member-side coupling means may be a coupling device other than the rubber bush devices (e.g., a bush device made from a material other than rubber).

Further, in the foregoing third embodiment of the invention, in the range between one end of the suspension arm 10 and the central portion thereof, the flat upper lid member 96 and the flat lower lid member 98 are hung across the region between the flange portions 20B and 20C of the arm member 20 and the region between the flange portions 22B and 22C of the arm member 22 respectively. However, the range in which the upper lid member 96 and the lower lid member 98 are hung may be changed, and the upper lid member 96 and the lower lid member 98 may be omitted.

Further, in each of the foregoing embodiments of the invention, the arm members 20 and 22 are pivotably coupled at one end thereof to the vehicle body 14, and are pivotably coupled at the other end thereof to the wheel support member 18.

However, the arm members 20 and 22 may be securely coupled at least one of one end thereof and the other end thereof to a corresponding one of the vehicle body and the wheel support member in a manner that does not allow relative displacement.

Further, in each of the foregoing embodiments of the invention, the arm members 20 and 22 are members extending rectilinearly, and the suspension arm 10 is also a rectilinear suspension arm structured such that the centerline 24 and the lines 26 and 28 coupling the shear centers extend rectilinearly. However, the suspension arm according to the invention may be a curved suspension arm structured such that a centerline and lines coupling shear centers extend along a curve.

Further, the arm members 20 and 22 according to the foregoing first or second embodiment of the invention may be connected to each other by connection plates similar to the upper lid member 96 and the lower lid member 98 in the foregoing third embodiment of the invention.

While the invention has been described with reference to the example embodiments thereof, it should be understood that the invention is not limited to the example embodiments or constructions. To the contrary, the invention is intended to cover various modifications and equivalent arrangements. In addition, while the various elements of the example embodiments are shown in various combinations and configurations, which are exemplary, other combinations and configurations, including more, less or only a single element, are also within the spirit and scope of the invention.

1. A vehicle suspension arm coupled at one end thereof to a vehicle body and at the other end thereof to a wheel support member, comprising:
a pair of arm members spaced apart from each other,
wherein the pair of the arm members define a centerline of the suspension arm therebetween with the cooperation with each other, and
the arm members have shear centers that are located on the centerline side with respect to the arm members respectively.

2. The vehicle suspension arm according to claim 1, wherein the shear centers of the pair of the arm members are located on the centerline at least in part of a region between the one end and the other end.

3. The vehicle suspension arm according to claim 1, wherein the shear centers of the pair of the arm members are equidistantly spaced apart from each other with respect to the centerline at least in part of a region between the one end and the other end.

4. The vehicle suspension arm according to claim 1, wherein the pair of the arm members have cross-sectional shapes that establish a mirror image relationship with each other in at least part of a region between the one end and the other end.

5. The vehicle suspension arm according to claim 1, wherein the pair of the arm members are integrally connected to each other by a connection portion at least one of the one end and the other end.

6. The vehicle suspension arm according to claim 5, wherein
the connection portion is provided at the one end, and
the connection portion at the one end constitutes part of vehicle body-side coupling portion for pivotably coupling the one end of the suspension arm to the vehicle body.

7. The vehicle suspension arm according to claim 5, wherein
the connection portion is provided at the other end, and
the connection portion at the other end constitutes part of wheel support member-side coupling portion for pivotably coupling the other end of the suspension arm to the wheel support member.

8. The vehicle suspension arm according to claim 1, wherein
the common vehicle body side coupling portion pivotably couples the one ends of the arm members to the vehicle body and connects the one ends of the arm members with each other, and
the common wheel support member side coupling portion pivotably couples the other ends of the arm members to the wheel support member and connects the other ends of the arm members with each other.

9. The vehicle suspension arm according to claim 1, wherein
the respective arm members include regions where the cross-sectional shape is constant at least between the one end and the other end, and
the pair of the arm members are spaced apart from each other and disposed parallel to each other in the regions where cross-sectional shape is constant.

10. The vehicle suspension arm according to claim 9, wherein
the cross-sectional shapes is constant along an entire length of the respective arm members, and
the pair of the arm members are spaced apart from each other and disposed parallel to each other along the entire length of the arm members.

11. The vehicle suspension arm according to claim 1, wherein
the respective arm members include cross-section change regions in which distances between the arm members and an instantaneous center gradually increase in a direction from one side of the one end and the other end toward the other side between the one end and the other end, and
the pair of the arm members are separated by a distance that gradually increases from the one side toward the other side in the cross-section change regions.

12. The vehicle suspension arm according to claim 1, wherein
the suspension arm includes a shock absorber coupling portion between the one end and the other end, and
the pair of the arm members are connected to each other by two connection plates that are spaced apart from each other in a range between the one end and the shock absorber coupling portion, and have closed cross-sectional shapes in the range.

13. The vehicle suspension arm according to claim 12, wherein
one of the connection plates connects upper edges of the pair of the arm members in a vehicle vertical direction to each other, and
the other connection plate connects lower edges of the pair of the arm members in the vehicle vertical direction to each other.

14. The vehicle suspension arm according to claim 1, wherein the pair of the arm members have cross-sectional shapes in which both ends of each of the respective arm members opens to a side opposite to the centerline side.

15. The vehicle suspension arm according to claim 1, wherein
the suspension arm is pivotably coupled at the one end to the vehicle body around a pivot axis, and
the pivot axis at the one end intersects with the centerline at right angle thereto.

16. The vehicle suspension arm according to claim 1, wherein
the suspension arm is pivotably coupled at the other end to the wheel support member around a pivot axis, and
the pivot axis at the other end intersects with the centerline at right angle thereto.

17. The vehicle suspension arm according to claim 1, wherein
the suspension arm is pivotably coupled at the one end to the vehicle body around a pivot axis, and is pivotably coupled at the other end to the wheel support member around a pivot axis, and
the pivot axis at the one end and the pivot axis at the other end intersect with the centerline at right angle thereto and extend parallel to each other.

18. The vehicle suspension arm according to claim 3, wherein the suspension arm is pivotably coupled at the one end to the vehicle body around a pivot axis, and
the pivot axis at the one end intersects with the centerline at right angle thereto, and intersects with two lines connecting the shear centers of the respective arm members.

19. The vehicle suspension arm according to claim 3, wherein
the suspension arm is pivotably coupled at the other end to the wheel support member around a pivot axis, and
the pivot axis at the other end intersects with the centerline at right angle thereto, and intersects with two lines connecting the shear centers of the respective arm members.

20. The vehicle suspension arm according to claim 1, wherein
the suspension arm includes a stabilizer link coupling portion at a position between the one end and the other end, and
the pair of the arm members have cross-sections that are perpendicular to the centerline and a cross-sections area of the cross-sections is greatest at the stabilizer link coupling portion.
